(19) United States
(12) Patent Application Publication
(10) Pub. No.: US 2012/0186243 A1
(43) Pub. Date: Jul. 26, 2012

(54) HYDRAULIC SYSTEM HAVING AT LEAST ONE DRIVE MACHINE

(76) Inventors: Torsten VERKOYEN, Niederkruchten (DE); Thomas Duwel, Bochum (DE)

(21) Appl. No.: 13/353,757

(22) Filed: Jan. 19, 2012

(30) Foreign Application Priority Data
Jan. 20, 2011 (DE) 10 2011 000 239.1

(51) Int. Cl. F15B 15/02

(52) U.S. Cl. 60/421

(57) ABSTRACT

The invention relates to a hydraulic system having a pump and at least two working machines, in particular two working machines embodied as hydraulic cylinders. Each working machine is connected by pressure lines to the associated drive machine via two connectors that serve as an inflow or return. At least one valve is associated with each working machine, for adjusting the operating state of the working machine. In the context of an elevating work platform the connector which serves as an outflow in a working state of that working machine that is brought about or at least assisted by gravity is connected via a bypass, circumventing the drive machine, directly to the connector, serving as inflow in the context of a desired operating state, of another working machine, so that the hydraulic fluid flowing out from the first working machine flows for actuation of the other working machine.

### CROSS-REFERENCE TO RELATED APPLICATIONS AND CLAIM TO PRIORITY

This application is related to application number 10 2011 000 239.1, filed Jan. 20, 2011 in the Federal Republic of Germany, the disclosure of which is incorporated herein by reference and to which priority is claimed.

1. Field of the Invention

The invention relates to a hydraulic system having at least one drive machine, in particular a pump, and having at least two working machines, in particular two working machines embodied as hydraulic cylinders, each working machine being connected by means of corresponding pressure lines to the respectively associated drive machine via two connectors that serve, depending on the operating state of the working machine, respectively as an inflow or return; and having at least one valve, associated with each working machine, for adjusting the operating state of the respective working machine.

2. Background of the Invention

Hydraulic systems of this kind are used, for example, in elevating work platforms. Hydraulic resistance controllers are utilized to lift and lower loads. In this context, the volumetric flow of hydraulic fluid delivered by the working machine, in particular the pump, is directed through valves (resistances) to the working machines, for example to the hydraulic cylinders. The system pressure is established as a function of the loads at the working machines. The speed of a working machine is adjusted by way of the valve associated with that working machine. The farther the valve is opened, the higher the volumetric flow to that working machine and the faster, for example, a cylinder retracts or extends an elevating work platform.

The system pressure is lower upon retraction of the working machine than upon extension, since the load assists retraction as a result of gravity, in particular in the case of vertical retraction. In known hydraulic systems, the outflowing hydraulic oil is directed back via the corresponding valve into the tank. Energy losses can occur in this context.

In addition, no further energy can be introduced into the system in the event of failure, or when a pump is deactivated. The result is that working machines, such as hydraulic cylinders, that are under load can then only be retracted but no longer extended.

### SUMMARY OF THE INVENTION

An object of the invention is to avoid the aforementioned disadvantages and to describe a hydraulic system in which energy can be utilized in the context of retraction, for example in the context of an elevating work platform.

This object is achieved in that in the context of at least one working machine, that connector which serves as an outflow in the context of a working state of that working machine that is brought about or at least assisted by gravity is connected via a bypass, circumventing the drive machine, directly to the connector, serving as inflow in the context of a desired operating state, of another working machine, so that the hydraulic fluid flowing out from the first working machine flows for actuation of the other working machine.

The hydraulic system according to the present invention will be explained below using the example of an elevating work platform. In elevating work platforms, a pump that is driven via a suitable motor is provided as a drive machine. Hydraulic cylinders are provided as working machines. A tank is provided inside the hydraulic system, the pump being connected to the tank. It is, however, also entirely possible for the returned hydraulic fluid to be made available again directly to the pump.

Elevating work platforms comprise a boom system that is made up of several booms. In larger elevating work platforms in particular, a boom is made up of several sub-elements that can telescope into one another by way of a suitable hydraulic cylinder.

If the boom is in a vertical orientation and if the sub-elements are extended, the relevant hydraulic cylinder is also extended. Upon retraction of this boom, the hydraulic fluid present in the lower cavity of that hydraulic cylinder is forced by gravity into the bypass, and as a result of the configuration according to the present invention can be used to actuate another hydraulic cylinder. The hydraulic cylinder can in this way, for example, be extended in order to modify the orientation of the bucket.

The pump can work concurrently in assisting fashion. It is, however, of course also possible for the pump to be completely switched off in the context of this process. A “bypass” is understood as those solutions that circumvent the drive machine. It is also entirely possible for the bypass to be constituted simply by a circumventing line to the pump, and for a shutoff valve to be provided behind the pump, so that when the shutoff valve is closed, the hydraulic fluid is guided through the bypass and circumvents the pump. It is of course also possible for the pump simply to be switched off.

A valve can be provided in the bypass. This can be a flow control valve, so that the inflowing quantity can be adjusted. It is, however, of course also possible for the valve to be displaceable only between an on and an off position.

A working machine can be embodied as a closed hydraulic cylinder having a piston arranged displaceably in the hydraulic cylinder, the piston separating the hydraulic cylinder into two cavities and a piston rod being attached to the piston, which rod passes through a correspondingly embodied opening in a cylinder end surface, each cavity having associated with it a respective connector leading into that cavity.

It makes sense if a partition is provided at least in one cavity, preferably the one not penetrated by the piston rod, forming a sub-space with the adjoining cylinder end surface, the sub-space being connected to the relevant cavity via at least one opening in the partition, and the bypass opening into the sub-space. The opening is preferably arranged in the center of the partition. It further makes sense if the partition is arranged at a short distance from the cylinder end surface.

### BRIEF DESCRIPTION OF THE DRAWINGS

An exemplifying embodiment of the invention, depicted in the drawings, will be explained below. In the drawings:

FIG. 1 is a schematic sketch of a hydraulic system according to the present invention, and

FIG. 2 is a schematic sketch of an elevating work platform.

### DETAILED DESCRIPTION OF THE PREFERRED EMBODIMENT(S)

In all the Figures, matching reference characters are used for identical or similar components.

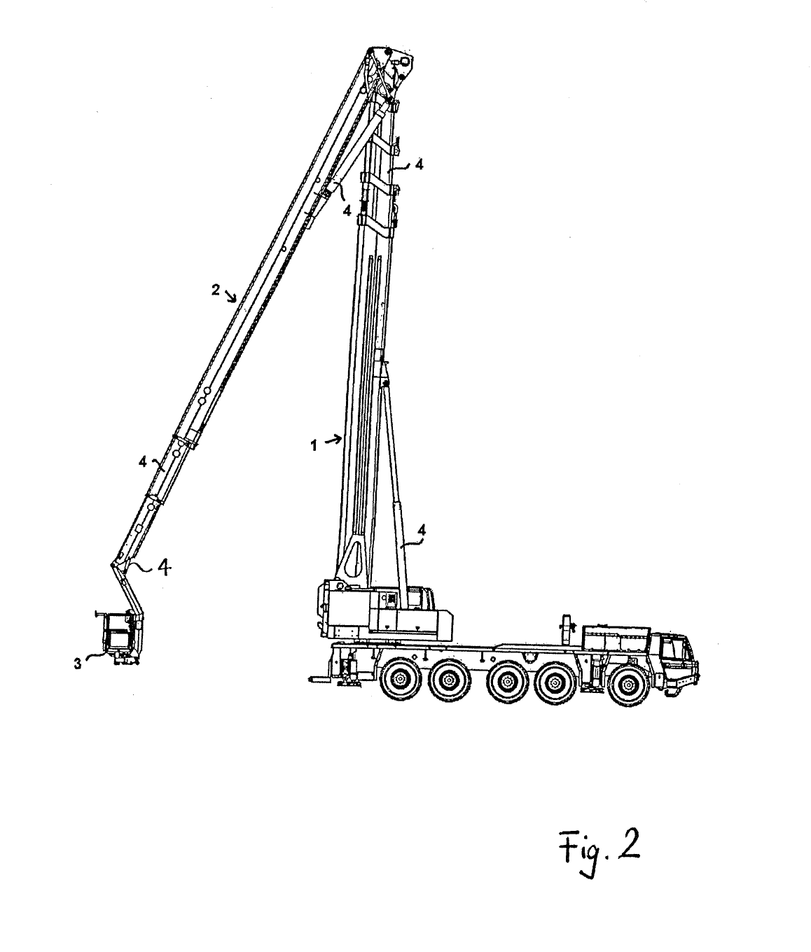

FIG. 2 depicts an elevating work platform having a boom system made up of a main boom 1, a secondary boom 2, and a bucket 3 attached at the end of secondary boom 2. Main boom 1 and secondary boom 2 are made up respectively of five and of three boom sub-elements that can telescope into one another.

A respective hydraulic cylinder 4 is provided for orienting main boom 1 and secondary boom 2. In addition, a respective hydraulic cylinder 4 is provided inside main boom 1 and inside secondary boom 2. A further hydraulic cylinder 4 engaging on bucket 3 is furthermore provided in order to enable bucket 3 to tilt with respect to secondary boom 2.

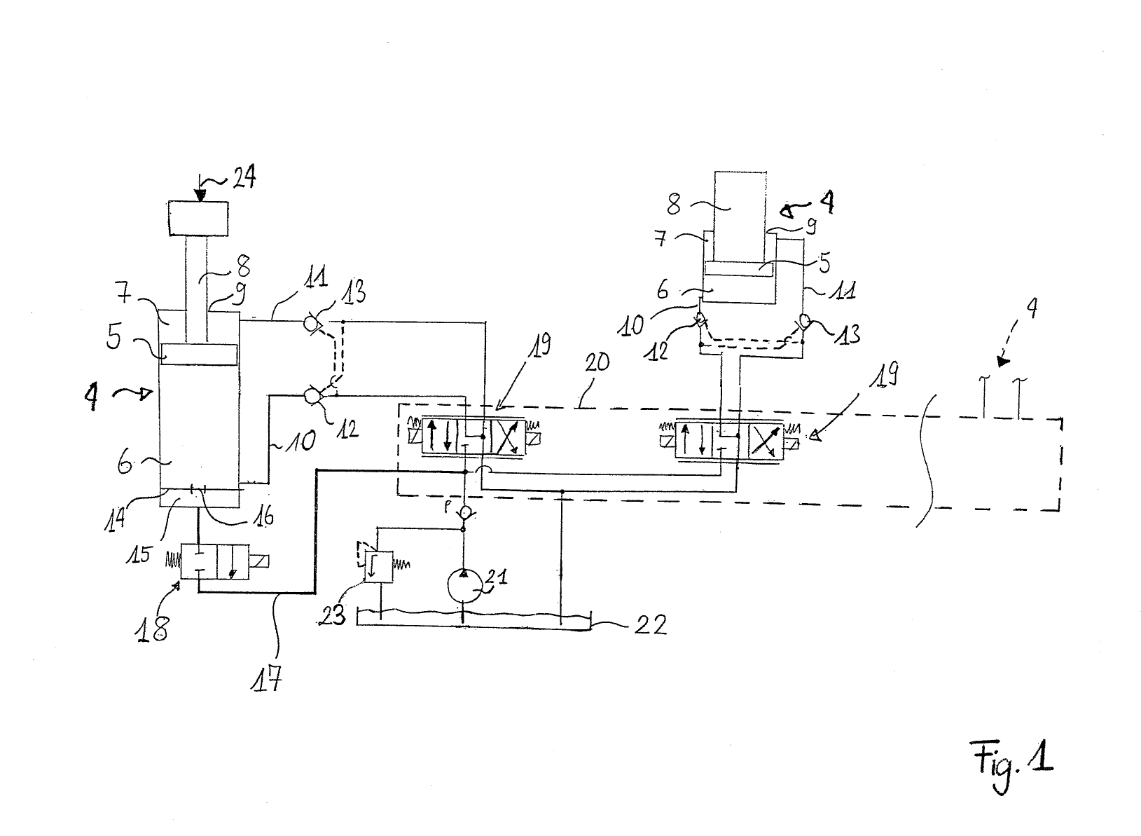

FIG. 1 depicts, by way of example, a circuit diagram of a hydraulic system according to the present invention, only two hydraulic cylinders 4, embodied as working machines, being depicted for the sake of simplicity. The left hydraulic cylinder 4 is, for example, hydraulic cylinder 4 for telescoping main boom 1 of the elevating work platform according to FIG. 2, while hydraulic cylinder 4 on the right in FIG. 1 is provided for orienting bucket 3.

Each hydraulic cylinder 4 comprises a piston 5 arranged displaceably in hydraulic cylinder 4, and is embodied in closed fashion. Piston 5 separates hydraulic cylinder 4 into two cavities 6, 7; attached on piston 5 is a piston rod 8 that is guided through a correspondingly embodied opening 9 in a cylinder end surface. Each cavity 6, 7 has associated with it a connector 10, 11 leading into that cavity 6, 7. Connectors 10, 11 serve as an inflow or return depending on the operating state of this main cylinder 4. A respective shutoff valve 12, 13 is provided in connectors 10, 11 in order to prevent undesired lowering of a load.

In the case of hydraulic cylinder 4 depicted on the left in FIG. 1, a partition 14 is provided in lower cavity 6 of hydraulic cylinder 4. Partition 14 forms, with the adjacent cylinder end surface, a sub-space 15. This sub-space 15 is connected to the adjacent cavity 6 via an opening 16 in partition 14. One end of a bypass 17 opens into sub-space 15. The other end of bypass 17 is connected to the connector, serving in a desired operating state as an inflow, of the right hydraulic cylinder 4. A valve 18 that is displaceable into two positions is provided in bypass 17. In the position of valve 18 that is depicted, bypass 17 is closed.

Partition 14 is arranged so that piston 5, in the completely retracted position, does not touch partition 14. The end position of piston 5 in the completely retracted state is adjusted so that piston 5 does not, on its periphery, cover the relevant connector 10.

A valve 19, which in the exemplifying embodiment depicted is shiftable into three different positions, is provided for each main cylinder 4 in order to adjust the operating state. Valves 19 can be arranged in one shared control block 20.

A pump, which is driven by a motor (not depicted), is provided as drive machine 21. A tank 22, in which the back-flowing hydraulic fluid is collected, is provided in the present case to store the hydraulic fluid. A pressure relief valve 23 is additionally associated with the pump.

In the position of the two valves 19 that is depicted, the position of pistons 5 of the two hydraulic cylinders 4 is not changed when the pump is activated.

If, for example, valve 19 of the left hydraulic cylinder 4 is shifted into the left position, hydraulic fluid is forced into lower cavity 6 of the left hydraulic cylinder 4 when the pump is activated. Piston 5 is consequently shifted upward and is thus extended, for example, in order to lift a load. Because of the decreasing volume of upper cavity 7, the hydraulic fluid located in upper cavity 7 is guided through valve 19 into tank 22.

In order to lower the load, i.e. to retract the left hydraulic cylinder 4 in the direction of arrow 24, valve 19 is shifted into the right position. As a consequence, hydraulic fluid is pumped by the pump into upper cavity 7. As a result of the displacement of piston 5, the hydraulic fluid located in lower cavity 6 is guided out of lower cavity 6 through outflow 10 into tank 22.

The bypass according to the present invention makes possible, as compared with known hydraulic systems, the procedure described below upon lowering of the load, i.e. upon retraction of the left hydraulic cylinder 4 in the direction of arrow 24. As a consequence of gravity, the hydraulic fluid flowing out of lower cavity 6 of the left hydraulic cylinder 4 is guided directly, circumventing the pump, into inflow 10 of, for example, lower cavity 6 of the right hydraulic cylinder 4. If valve 19 associated with the right hydraulic cylinder 4 is in the left position, the hydraulic fluid is consequently introduced into lower cavity 6 of the right hydraulic cylinder 4, and piston 5 is thus extended. The energy of the left hydraulic cylinder 4 that is made available by gravity can thus be utilized for the second hydraulic cylinder 4.

Further hydraulic cylinders 4, which are merely indicated in FIG. 1 for the sake of simplicity, can of course be provided in the hydraulic system. These too can be integrated into the hydraulic system in such a way that the energy stored by gravity in one hydraulic cylinder 4 is used for one or all of the other hydraulic cylinders 4.

A bypass 17 is thus integrated into the resistance controller in a known hydraulic system so that the hydraulic oil under pressure can be made available to another working machine. In the event of failure or when a pump is deactivated, energy can be introduced into the hydraulic system by way of hydraulic cylinder 4 that is under load. Main cylinder 4 depicted on the left in FIG. 1 thus acts as an energy reservoir for potential energy.

Any desired operation can be performed upon actuation of the corresponding valve(s). The above-described extension of, for example, the right main cylinder 4 against a load upon retraction of the left main cylinder 4 is also possible thanks to the stored energy. The left hydraulic cylinder 4, serving as an energy reservoir, thus slowly drops. The capability of operating a working machine against a load depends only the area ratios of hydraulic cylinders 4 and on the height of the loads. The magnitude of the stored energy depends on the stroke length of the “energy-storing” hydraulic cylinder 4 and on the load.

As the left hydraulic cylinder 4 drops, energy is withdrawn over time, i.e. power is generated in the form of pressure (p₁) times volumetric flow (Q₁). When bypass 17 is open and upon actuation of the corresponding valve 19, the power generated can be made available directly to the right hydraulic cylinder 4. In addition, the power (p₁*Q₁) generated by the left hydraulic cylinder 4 can be converted, via a component that is not depicted and not further specified, into the power output (p₂*Q₂) so that even loads that are greater than the load of the left hydraulic cylinder 4 can be lifted with, for example, the right hydraulic cylinder 4.

We claim:

1. A hydraulic system having at least one drive machine (21), in particular a pump, and having at least two working machines, in particular two working machines embodied as hydraulic cylinders (4), each working machine being connected by means of corresponding pressure lines to the respectively associated drive machine (21) via two connectors (10, 11) that serve, depending on the operating state of the working machine, respectively as an inflow or return; and having at least one valve (19), associated with each working machine, for adjusting the operating state of the respective working machine,
wherein in the context of at least one working machine, that connector (10, 11) which serves as an outflow in the context of a working state of that working machine that is brought about or at least assisted by gravity is connected via a bypass (17), circumventing the drive machine (21), directly to the connector (10, 11), serving as inflow in the context of a desired operating state, of another working machine, so that the hydraulic fluid flowing out from the first working machine flows for actuation of the other working machine.

2. The system according to claim 1, wherein a valve (18) is provided in the bypass (17).

3. The system according to claim 1, wherein a working machine is embodied as a closed hydraulic cylinder (4) having a piston (5) arranged displaceably in the hydraulic cylinder (4), the piston (5) separating the hydraulic cylinder (4) into two cavities (6, 7) and a piston rod (8) being attached to the piston (5), which rod passes through a correspondingly embodied opening (9) in a cylinder end surface, each cavity (6, 7) having associated with it a respective connector (10, 11) leading into that cavity (6, 7).

4. The system according to claim 3, wherein a partition (14) is provided at least in one cavity (6, 7), preferably the one not penetrated by the piston rod (8), forming a sub-space (15) with the adjoining cylinder end surface, the sub-space (15) being connected to the relevant cavity (6, 7) via at least one opening (16) in the partition (14), and the bypass (17) opening into the sub-space (15).

5. The system according to claim 2, wherein a working machine is embodied as a closed hydraulic cylinder (4) having a piston (5) arranged displaceably in the hydraulic cylinder (4), the piston (5) separating the hydraulic cylinder (4) into two cavities (6, 7) and a piston rod (8) being attached to the piston (5), which rod passes through a correspondingly embodied opening (9) in a cylinder end surface, each cavity (6, 7) having associated with it a respective connector (10, 11) leading into that cavity (6, 7).

6. The system according to claim 5, wherein a partition (14) is provided at least in one cavity (6, 7), preferably the one not penetrated by the piston rod (8), forming a sub-space (15) with the adjoining cylinder end surface, the sub-space (15) being connected to the relevant cavity (6, 7) via at least one opening (16) in the partition (14), and the bypass (17) opening into the sub-space (15).
